(19) United States
(12) Patent Application Publication
(10) Pub. No.: US 2005/0115878 A1
(43) Pub. Date: Jun. 2, 2005

(54) System for desalinating and purifying seawater and devices for the system

(76) Inventor: Ching-Piau Lai, Goushing (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/726,190

(22) Filed: Dec. 1, 2003

(51) Int. Cl. B01D 3/00

(52) U.S. Cl. 210/175; 202/163

(57) ABSTRACT

A system for desalinating and purifying seawater to transform the seawater into drinkable water includes devices including a top layer, a bottom layer and an outer cooling assembly and four units correspondingly arranged in devices, wherein the top and bottom layers both have inner walls made of thermal-conductive and anti-corrosive material. The four units are a heating unit and a desalinating cracking unit within the bottom layer, a purifying distilling unit within the top layer, and a cooling unit within the outer cooling assembly.

### FIELD OF THE INVENTION

In general, the present invention relates to a system for desalinating and purifying seawater until the seawater becomes drinkable, and more particularly to a system that has a cyclically desalinating process and a repeatedly purifying process to crack elements in water molecules in the seawater to tiniest molecules and therewith to reform to become drinkable water derived from the oceans. Wherein, viruses, heavy-metallic pollutants and futile elements contained in the seawater are separated and removed to make the fresh water safe without extra treatment and molecular elements contained in the generated drinkable water easily absorbed and utilized by human body.

### BACKGROUND OF THE INVENTION

Recently, water supplement becomes a worldwide problem. People will face the water shortage in the futures and need an effective solution to resolve the problem of water shortage. Although the earth contains plenty of water, most of the water is seawater (salt water) in the oceans and is not drinkable because the seawater contains too much crude salt containing sodium chloride, non-metallic elements, heavy metals and thousands of unknown elements. Several desalinating methods for the seawater or brine are developed and mainly classified into two types. One type is to use membrane isolation such as reverse-osmosis or electrodialysis. The reverse-osmosis is suitable for desalinating seawater and the electric dialysis is suitable for treating brine containing less quantity of salt. With regard to the reverse-osmosis, electricity consumption and membrane reloading cause an inevitable spending that takes a majority portion in an operational cost of reverse-osmosis. Another type is to distill the seawater, which is a common method used to separate high-volatility materials from non-volatility and low-volatility materials. Wherein, the high-volatility materials are vaporized to obtain the non-volatility and low volatility materials or further the vaporized high-volatility materials are cooled to obtain pure liquids thereof. Distillation-type desalinating methods comprise multi-effect Distillation (MSD), multi-stage flash (MSF), vapor compression (VC) etc. and basically reuse generated heat in an operational system to serve as a heat source of distillation. Therefore, the distillation-type desalinating methods focus on improving thermal-transmission efficiency of equipment in this method.

The foregoing reverse-osmosis method is operated by simple equipment and simple operational procedures and is selectively designed to be small modules or combined with other desalinating systems to become a large-scale desalinating system in a factory. But the reverse-osmosis method has high operational pressure and need more electricity to operate the equipment so that operating cost of the reverse-osmosis method is high. Although the distillation-type desalinating method uses waste heat as a power source, vaporizing and condensing processes must be hold in two separated chambers so that equipment of the distillation-type desalinating method occupies more space than that of the reverse-osmosis method. Additionally, the distillation-type desalinating method is difficult to be operated and controlled. Up to now, the two conventional types of desalinating methods both have high costs and the generated water has less competitive capabilities with naturally obtained fresh water. Moreover, still another desalinating method, so-called membrane-distillation method, which combines advantages of the membrane-osmosis method and the distillation method together. However, the membrane-distillation method has low producing rate (water quantity/per volume unit of equipment) and is easily malfunctioned by blocking porous membranes with crystallization. Therefore, the membrane-distillation method is not widely applied in desalinating systems.

Additionally, still several conventional treatments for tap water are listed and compared in the followings:

1. Boiling method: boiling method can kill bacteria in water but can not remove harmful impurities from water. Moreover, the tap water mostly contains chlorides therein and the chlorides easily become cancer-inducing material, chloroform, after boiling.

2. Filtering method with active carbon: the active carbon can absorbs organic materials and colloids in the water and deodorizes the tap water, but the active carbon has to be changed very often.

3. Ion-exchanging method: ion-exchanging resin is applied to remove metallic ions, such as sodium, magnesium, and calcium ions etc., from the tap water to soften the tap water but can not purify the top water.

4. Ultraviolet (UV) lighting method: the UV lighting method can kill the bacterial but can not remove salt, colloid, particles, and other chemicals from the tap water.

5. Depositing method: the depositing method can not kill bacteria and viruses and can not eliminate heavy metals and toxic chemicals in the tap water.

Moreover, water obtained from desalinated seawater by the conventional desalinating methods still contains some salt and some mineral materials (metallic or non-metallic materials) and is only suitable for washing or irrigation, but is not drinkable. Therefore, the water has to be mixed with fresh water to further boil or filter again to become drinkable. With regard to water obtained from distillation-type desalinating method, the water is almost pure water but still contains some sodium and halogen elements because compounds containing sodium and halogen are vaporized and then reduced into the water after condensation so that the water is harmful to metabolism system of human body if the water is drank without any extra treatment to remove the sodium and halogen compounds. Moreover, some beneficial mineral materials in the water are decomposed after distillation.

According to foregoing desalinating methods, these methods have less concern about the purification. Without purification, the water obtained from desalinating methods still contains small quantity of salts and mineral materials and is not drinkable. For the conventional desalinating methods in present, majority of salt and gesso are removed from the seawater but the generated water obtained from desalinating still contains sodium and halogen elements and is harmful to metabolism system of human body. Additionally, specifically for distillation-type desalinating method, the boilers in the operational system are easily coated with limescale and corroded by corrosive materials in the seawater so that operational system of this method has to be interrupted to clean or change the boilers. Therefore, the boilers have short utility periods and an operational cost of the distillation-type desalinating method is increased.

### SUMMARY OF THE INVENTION

The present invent invention provides a system for desalinating and purifying seawater to overcome these drawbacks in the conventional desalinating methods by using a heating unit, a desalinating cracking unit, and a purifying distilling unit cyclically arranged in this system and further by incorporating with a dissociating reducing device proceeding a multi-desalinating process and multiple distillatories proceeding a repeatedly purifying process to reform the seawater into drinkable water without extra treatment. Moreover, molecular elements in the generated drinkable water can be absorbed and utilized by human body after drinking.

The system for desalinating and purifying seawater in the present invention essentially imitates natural circulation of water on the earth. Rotation of the earth makes the oceans to generate cold and warm currents to convect with each other so that frictions between the currents are generated under the sea. By the frictions, toxic elements and pollutants in the seawater are vaporized, cracked, and then reformed to become other synthetic elements and materials. Additionally, radiation of sunlight penetrates the atmosphere layer and is refracted by different water molecular groups in the atmosphere layer to cause electronic mobility. Therefore, when the sunlight radiates the seawater with highly thermal radiation to vaporize water, vaporized water molecules has multi-friction with the radiation during vaporization. Light elements in the seawater are vaporized to join the atmosphere layer and residual elements in the seawater are cracked by friction and reformed to become tinier water molecular groups. Mostly, elements having high specific gravity and organic pollutants are cracked For example, organic pollutants such as bacteria and odors can be decomposed by oxidizing reaction caused from lighting titanium dioxide by UV light. Wherein, the titanium dioxide generates a pair of electron and electron hole and then generates free hydroxide radical (OH⁻) having high oxidizing capability to decomposed the bacteria and odor to purify the seawater. The vaporized water molecules are cooled by air and condensed to become raindrops falling to the ground. Some raindrops falling into rivers dissolve impure elements on the ground and return to the ocean. The raindrops in the ocean are recombined with other elements in the ocean to become the seawater. Some raindrops are stored on the ground to perform lakes or permeate the ground to become groundwater. The raindrops are filtered by multiple geology strata to become pure groundwater (the cleanest original water) that has different quality and quantity with water on the ground. Principles and techniques in the present invention are essentially based on the natural circulation of water and imitate vaporization caused by heat of the earth core. Additionally, a desalinating cracking unit in the system of the present invention has a dissociating reducing device, which has functions similar as those of the earth geologic strata and ground, attached to a bottom of the desalinating cracking unit.

A first technical character of the present invention is that the system comprises multiple separable devices including a top layer, a bottom layer, and an outer cooling assembly, and four units arranged within corresponding layers and the outer cooling assembly to allow the system to be constructed and cleaned easily. The devices are made of ceramics or other materials having excellent thermal-conducting and anti-corrosive capabilities to eliminate coating of limescale and corrosion to the devices so as to avoid malfunction of the devices. Additionally, the heating unit has an impurity depositing area with an impurity outlet attached to a bottom of the heating unit to collect and discard impurity and non-volatile materials via the impurity outlet.

A second technical character of the present invention is that the heating unit is modified to comprise a heater to heat the seawater inside the system to cause currents flowing in the system to accelerate boiling of the seawater.

A third technical character of the present invention is that the desalinating cracking unit has at least one steam heater to provide extra heating efficiency and to drive the seawater to vortically rotate when the seawater boils.

A fourth technical character of the present invention is that the desalinating cracking unit has a dissociating reducing device having similar functions as those in the geologic strata and the ground. By impact effects of the steam induced by the steam heater and the dissociating reducing device, vibrational cracking occurs to crack and reform the water molecules in the steam. Heavy metals and heavy water in the seawater are separated from light elements in the water molecules in the steam and further conducted to the heating unit to be vaporized again. The steam of water molecules containing light elements is conducted to the purifying distilling unit in the top layer.

A fifth technical character of the present invention is that the purifying distilling unit comprises multiple distillatories. Each distillatory is composed of multiple manifolds. By a physically inducing effect caused by impact of high temperature steam and the multiple manifolds, the steam is further sieved to allow tiny elements in the water molecules in the steam to pass through the purifying distilling unit to reach the outer cooling assembly. Residual steam unable to pass through the purifying distilling unit is conducted back to the desalinating cracking unit in the bottom layer.

### BRIEF DESCRIPTION OF THE DRAWINGS

FIG. 1 is a schematically flowchart of a system for desalinating and purifying seawater in accordance with the present invention; and

FIG. 2 is a cross-sectional side plane view of devices applied to the system in the present invention.

### DETAILED DESCRIPTION OF THE PREFERRED EMBODIMENT

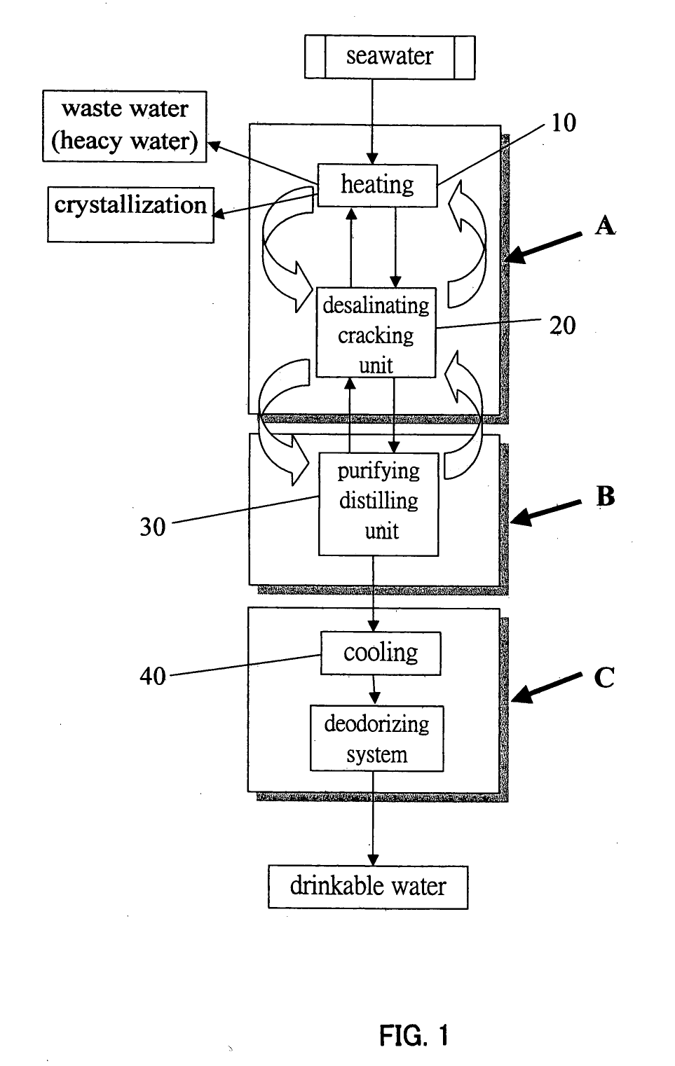

A system for desalinating and purifying seawater in the present invention is shown schematically in FIG. 1 in a generalized fashion. The system is designed for a separably multilayer configuration and comprises multiple devices containing a bottom layer (A), a top layer (B), and an outer cooling assembly (C) and four units correspondingly arranged in the multiple devices. The bottom layer (A) contains a heating unit (10) and a desalinating cracking unit (20). The top layer (B) contains a purifying distilling unit (30) and the outer cooling assembly (C) contains a cooling unit (40). Initially, the seawater is conducted into the heating unit (10) and partially vaporized to form steam flowing into the desalinating cracking unit (20). The heating unit (10) and the desalinating cracking unit (20) communicate with each other to achieve a cyclically and repeatedly desalinating process (as shown by arrows in FIG. 1). The seawater mixed with the steam runs in the cyclically and repeatedly desalinating process until non-boiling and non-crackable materials are generated in the seawater. The non-boiling and non-crackable materials in form of crystallization and are collected in the heating unit (10) by deposition and then drained with waste water (heavy water). After running in the cyclically desalinating process, the steam is conducted into the purifying distilling unit (30). Additionally, the desalinating cracking unit (20) and the purifying distilling unit (30) also communicate with each other to achieve a cyclically and repeatedly purifying process. In the purifying distilling unit (30), part of the steam unable to pass through the purifying distilling unit (30) is conducted back to the desalinating cracking unit (20). Residual tiniest steam and tiny elements within the water molecule able to pass through the purifying distilling unit (30) are conducted to the cooling unit (40) in the outer cooling assembly (C) to be condensed and deodorized to finally achieve drinkable water.

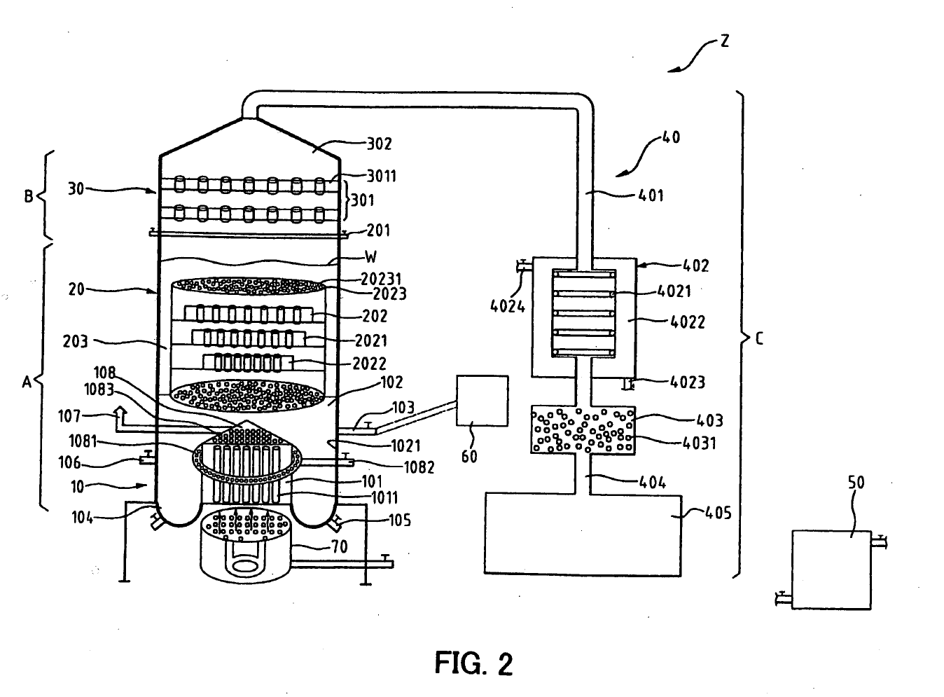

With reference to FIG. 2, preferred embodiments of the devices applied to the system for desalinating and purifying seawater are shown in a general fashion. A desalinating and purifying combination (Z) has a separably multilayer configuration and comprises a bottom layer (A), a top layer (B), an outer cooling assembly (C), and four units arranged in the desalinating and purifying combination (Z). The bottom layer (A) contains a heating unit (10) and a desalinating cracking unit (20). The top layer (B) contains a purifying distilling unit (30) and the outer cooling assembly (C) contains a cooling unit (40) and a deodorizing system (403). The bottom layer (A) has a bottom and the heating unit (10) is constructed at the bottom of the bottom layer (A). The heating unit (10) with a base (not numbered) has at least one heater (101), at least one steam heater (108), a heating chamber (102), a water inlet (103), an impurity depositing area (104), an impurity outlet (105) and a waste water outlet (106). The at least one heater (101) connects to the base of the heating unit (10) to directly receive heat generated from a heating device (70). Preferably, the at least one heater in the heating unit comprises multiple stainless steel tubes evenly arranged in a circle. The heating chamber (102) has an inner wall made of thermal-conductive and anti-corrosive material to serve as a thermal-exchanging wall (1021). The at least one steam heater (108) is a cone object composed of multiple circular steam pipes and further has an outer steam pipe (1081) surrounding around and connecting with an outer periphery of the cone object. Multiple obliquely gas nozzles (1083) are respectively attached to the cone object of the steam heater (108) and the outer steam pipe (1081). A steam inlet (1082) is formed at one side of the outer steam pipe (1081) and a waste gas exhaust (107) is formed at another side to be opposite to the steam inlet (1082). The at least one heater (101) and the heating chamber (102) simultaneously heat the seawater to cause circulation and to accelerate the boiling of the seawater. The steam heater (108) heats the seawater to make the seawater to generate a vortical circulation and to further accelerate the boiling of the seawater so that more steam is generated to flow into the desalinating cracking unit (20). Wherein, the steam inlet (1082) introduces extra steam from outside boilers into the heating chamber (102) to provide additional thermal energy. The water inlet (103) communicates to the heating chamber (102) to supply the seawater from the oceans by pumps into the heating unit (10). The impurity depositing area (104) is defined at the bottom of the bottom layer (A) to store deposited impurities in the seawater and the impurity outlet (105) communicates to the impurity depositing area (104) to drain the deposited impurities out of the heating unit (10). The waste water outlet (106) communicates to the heating chamber (102) above the impurity depositing area (104) to conveniently drain residual heavy water out of the heating unit (10). The waste gas exhaust (107) also communicates to the heating chamber (102) above the waste water outlet (106) to exhaust anhydrous gas out of the heating unit (10).

The desalinating cracking unit (20) above the heating unit (10) contains a dissociating reducing device (202) and a containing chamber (203) defined around the dissociating reducing device (202). The dissociating reducing device (202) is composed of multiple cracking layers (2021) vertically piled together and is in shape of cylinder. Preferably, the reducing device (202) is designed for a boiler. Wherein, each cracking layer (2021) has a top plate (2023), a bottom plate (not numbered) and multiple manifolds (2022) arranged between the top and the bottom plates. The top plate (2023) and the bottom plate are made of stainless steel and both have multiple round holes (20231) defined thereon. The containing chamber (203) has an inner wall made of thermal-conductive and anti-corrosive material. The at least one steam heater (108) in the heating unit (10) and the dissociating reducing device (202) interact each other to cause vibrating and cracking effects to dissociate and crack water molecules in the seawater. Thereby, heavy metal and heavy water are separated from light elements in the water molecules. Heavier and impure seawater is conducted back to the heating unit (10) to be vaporized again. Lighter and cleaner steam is introduced into the purifying distilling unit (30) in the top layer (B). In the desalinating cracking unit (20), the seawater in the containing chamber (203) are basically divided into two layers, one layer is an upper layer contains the lighter and cleaner seawater after cracking and desalinating, the other layer is a lower layer in where the seawater is cracking.

The top layer (B) contains the purifying distilling unit (30) composed of multiple distillatories (301). Each distillatory (301) has multiple manifolds (3011) and a steam chamber (302) is defined around the multiple distillatories (301). The steam chamber (302) has an inner wall made of thermal-conductive and anti-corrosive material. The multiple manifolds (3011) in each distillatory (301) and the multiple distillatory impact with high temperature steams pressure to cause a physically inducing effect. Thereby, water molecules in the steam are sieved to allow the tiniest steam and tiny elements in the water molecules passing through the purifying distilling unit (30) to reach the outer cooling assembly (C). Residual steam unable to pass through the purifying distilling unit (30) is conducted back to the desalinating cracking unit (20) in the bottom layer (A).

Additionally, the bottom layer (A) and the top layer (B) are detachably and air-tightly combined by means of engaging ring (201) to construct a cylindrical tower.

The outer cooling assembly (C) containing the cooling unit (40) and the deodorizing system (403) is connected to the top layer (B) via a pipe (401). Each cooling unit (40) has at least one cooling column (402), multiple coolers (4021) accommodated inside each cooling column (402), and a water chamber (4022) defined around the multiple coolers (4021) in the corresponding cooling column (402). The sieved steam from the purifying distilling unit (30) is introduced into the at least one cooler (4021) via the pipe (401) to further be condensed. A water outlet (4024) is attached to a top of the cooling column (402) and a water inlet (4023) is attached to a bottom of the cooling column (402) to introduce cool water, iced water, or the seawater into the water chamber (4022) to condense the steam to become condensing water. After condensing the steam, the cool water, iced water or the seawater in the cooling column (402) becomes hot and is drain out via the water outlet (4024). Selectively, the hot seawater is directly introduced into the heating unit (10) to process in the desalinating and purifying system to avoid thermal waste. The condensing water is conducted to the deodorizing system (403) below the cooling column (402), wherein the deodorizing system is filled with deodorizing material or de-chloride materials such as active carbon to purify the condensing water. Lastly, the purified water is drained out via an outlet (404) and collected in a container (405).

The seawater is filtered by a filtering device (50) before introduce into the system to remove large particles from the seawater. Then, the filtered seawater is conducted into the heating chamber (102) in heating unit (10) via the outer inlet (103) to reach a water level (W) over the dissociating reducing device (202) in the containing chamber (203) of the desalinating cracking unit (20). The heating device (70) secured on the base of the heating unit (10) selectively use fuel gas, gasoline, electricity or solar energy or steams as power to supply heat to the heater (101) in the heating unit (10). The heater (101) is composed of multiple stainless steel tubes (1011) arranged in cylinder and thus has large heating areas to cause the heated seawater to circulate in the heating chamber (102) to accelerate boiling of the seawater. Because the inner wall of the heating chamber (102) is a heat-exchanging wall made of thermal-conductive and anti-corrosive material, the inner wall of the heating chamber (102) absorbs thermal energy from the heated seawater to evenly heat the seawater in the entire heating chamber (102) to accelerate boiling of the seawater. After boiling, light elements and water molecules are transformed into steam bubbles to arise to the steam heater (108) in the seawater. The steam heater (108) and the outer steam pipe (1081) further heat the steam up and the obliquely gas nozzles (1083) inject gas to drive the seawater to vortically rotate to accelerate the boiling. Meanwhile, the steam bubbles in the steam heater (108) rapidly raise to the desalinating cracking unit (20). Additionally, the steam inlet (1082) attached on one side of the outer steam pipe (1081) introduces extra steam for heating and the waste gas exhaust (107) drain anhydrous waste gas out of the steam heater (108). After arrive the desalinating cracking unit (20), the steam bubbles pass the round holes (2023 1) on the bottom plate to impact with the dissociating reducing device (202) at high temperature and at high speed. The dissociating reducing device (202) generates a vibrating reaction to dissociate heavy elements such as toxic elements, heavy metal compounds, salts, and calcium carbonate and to separate these heavy elements from light elements in the water molecules. Since the seawater impact with the dissociating reducing device (202) to provide thermal energy, hydrogen and oxygen elements in the water molecules enable to be burned to accelerate vaporization of the light elements in the water molecules and other trace elements dialyzed from the seawater. The heavy elements are recombined with the heavy water and sunk to the heating unit (10) to re-boil again. The light elements with the water molecules arise to the desalinating cracking unit (20) and repeatedly boiling and cracking processes until non-boiling and non-cracking impurities generate. The impurities are deposited and collected in the impurity depositing area (104) and then drained out via the impurity outlet (105). The impurities enable be properly treated and reused.

After dissociate in the dissociating reducing device (20), the light elements with water molecules in form of steam depart from the water level (W) and enter the steam chamber (302) in the purifying distilling unit (30). The steam compact with the manifolds (3011) in the multiple distillatories (301) to cause a physically conducting effect and is sieved to allow tiniest water molecules carrying tiny elements to pass through the purifying distilling unit (30) to reach the outer cooling assembly (C). Each distillatory (301) is an inverted dome with a top convex surface and a bottom concave surface to gather and guide residual steam back to the desalinating cracking unit (20) to crack again and regenerate steam. The tiniest water molecules with tiny elements are still in form of steam called distillation steam in the following description. The distillation steam is introduced into the cooling unit (40) in the outer cooling assembly (C) via the pipe (401) and condensed by the multiple coolers (4021) in the cooling column (402). When condense the distillation steam, cool water, iced water, or the seawater is introduced into the water chamber (4022) via the water inlet (4023) to carry out heat-exchange with the distillation steam and then is drained out of the water chamber (4022) via the water outlet (4024). Therefore, the distillation steam can be rapidly condensed to become condensing water. Selectively, the seawater getting hot in the water chamber (4022) is directly introduced into the heating unit (10) to process in the desalinating and purifying system to save more thermal energy. Then, the condensing water is conducted to the deodorizing system (403) below the cooling column (402), wherein the deodorizing system (403) is filled with deodorizing material or de-chloride materials such as active carbon to purify the condensing water. Lastly, the purified water is drained out of the deodorizing system (403) via the outlet (404) and collected in the container (405).

Preferably, the seawater is pre-treated with the filtering device (50) to remove large particles from the seawater before feeding into the heating chamber (102) in the heating unit (10). Thereby, operational period of the system is shortened and impurities in the system are decreased.

When the system needs to be cleaned, a detergent supplier (60) is connected to the water inlet ( 103) to input detergent into the system, wherein the detergent is preferred to be non-toxic citric acid. The waste water outlet (106) and the impurity outlet (105) enable to respectively drain residual heavy water and impurities out the system. Because the inner walls of the heating chamber (102) and the containing chamber (203) are made of stainless steel, devices in the system are not easily coated with limescale and not be corroded by the seawater to reduce frequency of cleaning the system.

Main feature of the present invention is to use cyclically and repeatedly desalinating processes and purifying processes to purify the seawater to generate drinkable water containing trace elements that is beneficial for human body. Although particular and specific embodiments of the invention have been disclosed in some detail, numerous modifications will occurs to those having skill in the art, which modifications hold true to the spirit of this invention. Such modifications are deemed to be within the scope of the following claims.

1. A system for desalinating and purifying seawater to become drinkable water and devices thereof, the system and the devices comprising:
a bottom layer having
a heating unit with a base comprising a heating chamber with a bottom and an inner wall made of thermal-conductive and anti-corrosive material, at least one heater accommodated inside the heating chamber, at least one stem heater accommodated inside the heating chamber above the at least one heater, an impurity depositing area defined in the bottom of the heating chamber, an impurity outlet communicating with the impurity depositing area, a water inlet communicating with the heating chamber, and an waste water outlet communicating with the heating chamber above the impurity depositing area, wherein the at least one heater is connected to the base of the heating unit and adapted to receive thermal energy from a heating device; and
a desalinating cracking unit mounted over the heating unit to crack the seawater and generate steam and comprising a containing chamber with an inner wall made of thermal-conductive and anti-corrosive material, a dissociating reducing device accommodated inside the containing chamber;
a top layer detachably mounted on the bottom layer and having
a purifying distilling unit communicated with the desalinating cracking unit and comprising multiple distillatories, wherein each distillatory has multiple manifolds to compact with the steam to cause physically conducting effect so that the steam is sieved to allow only tiniest steam with tiny element in the water molecules to pass through the purifying distilling unit and residual steam is conducted back to the desalinating cracking unit; and
an outer cooling assembly connected to the top layer to receive the tiniest steam from the purifying distilling unit and having
a cooling unit comprising at least one cooling column to condense the tiniest steam to become condensing water; and
a deodorizing system communicating with the at least one cooling column to deodorize the condensing water and to remove chlorides from the condensing water to achieve drinkable water;
wherein, the heating unit and the desalinating cracking unit communicate with each other to achieve a cyclically and repeatedly desalinating process and the desalinating cracking unit and the purifying distilling unit also communicate with each other to achieve a cyclically and repeatedly purifying process to desalinate, purify and reform the seawater to generate the drinkable water.

2. The system and the devices as claimed in claim 1, wherein the at least one heater in the heating unit comprises multiple stainless steel tubes evenly arranged in a circle.

3. The system and the devices as claimed in claim 1, wherein the water inlet in the heating system is further connected to a filtering device to filter the seawater before the seawater is introduced into the system.

4. The system and the devices as claimed in claim 1, wherein the water inlet in the heating system is further connected to a detergent supplier to input detergent to clean the system.

5. The system and the devices as claimed in claim 4, wherein the detergent is nontoxic citric acid.

6. The system and the devices as claimed in claim 1, wherein the water inlet in the heating system conducts the seawater from the ocean by pump.

7. The system and the devices as claimed in claim 3, wherein the filtering device filters the seawater to remove particles in the seawater before the seawater is introduced into the system.

8. The system and the devices as claimed-in claim 1, wherein the at least one steam heater reheats the seawater to boil and drives the seawater to vortically rotate.

9. The system and devices as claimed in claim 1, wherein the at least one steam heater is a cone object made of multiple circular steam pipes.

10. The system and the devices as claimed in claim 9, wherein the at least one steam heater further comprises an outer steam pipe surrounding around and connecting with the cone object.

11. The system and the devices as claimed in claim 10, wherein multiple obliquely gas-nozzles are attached on the outer steam pipe.

12. The system and the devices as claimed in claim 10, wherein the outer steam pipe has two ends and at least one steam inlet attached to one end of the outer steam pipe.

13. The system and the devices as claimed in claim 12, wherein at least one waste gas exhaust is attached to the other end of the outer steam pipe.

14. The system and the devices as claimed in claim 12, wherein the at least one steam inlet introduces steam into the heating chamber to heat the seawater.

15. The system and the devices as claimed in claim 9, wherein multiple obliquely gas-nozzles are respectively attached on the multiple circular steam pipes.

16. The system and the devices as claimed in claim 9, wherein the cone object of the at least one steam heater caps over the heater.

17. The system and the device as claimed in claim 1, wherein the dissociating reducing device in the desalinating cracking unit impacts with boiling seawater to cause a vibrating and cracking reaction to dissociate the elements in the seawater.

18. The system and the devices as claimed in claim 1, wherein the dissociating reducing device is made of ceramics.

19. The system and the devices as claimed in claim 1, wherein the dissociating reducing device is in shape of cylinder.

20. The system and the devices as claimed in claim 1, wherein the dissociating reducing device is designed for a boiler.

21. The system and the devices as claimed in claim 1, wherein the dissociating reducing device comprises multiple cracking layers.

22. The system and the devices as claimed in claim 21, wherein each cracking layer has multiple manifolds.

23. The system and the devices as claimed in claim 22, wherein the dissociating reducing device has a top plate and a bottom plate both made of stainless steel to clamp the multiple cracking layers between the top plate and the bottom plate.

24. The system and the devices as claimed in claim 23, wherein multiple round holes are respectively defined through the top plate and the bottom plate.

25. The system and the devices as claimed in claim 1, wherein each distillatory is made of ceramics.

26. The system and the devices as claimed in claim 1, wherein each distillatory is dome-shaped and has a top convex surface and a bottom concave surface.

27. The system and the devices as claimed in claim 1, wherein each cooling column comprises at least one cooler.

28. The system and devices as claimed in claim 27, wherein the outer cooling assembly further has a water chamber with a top and a bottom to accommodate the at least one cooling column.

29. The system and the devices as claimed in claim 28, wherein a water outlet communicates with the water chamber near the top of the water chamber.

30. The system and the devices as claimed in claim 28, wherein a water inlet communicates with the water chamber near the bottom of the water chamber.

31. The system and the devices as claimed in claim 28, wherein the top layer and the bottom layer are detachably and air-tightly engaged by means of engaging rings.
